(19) United States
(12) Patent Application Publication
(10) Pub. No.: US 2023/0066671 A1
(43) Pub. Date: Mar. 2, 2023

(54) PLANT AND METHOD FOR THE ABATEMENT OF UNDESIRED POLLUTING COMPONENTS CONTAINED IN BIOGAS TO BE TREATED

(71) Applicant: AB IMPIANTI SRL, ORZINUOVI, BS (IT)

(72) Inventors: Emanuele CHIODI, BORGO SAN GIACOMO, BRESCIA (IT); Marco FERRARI, QUINZANELLO, BRESCIA (IT); Fabio SAPPA, ORZIVECCHI, BRESCIA (IT); Egidio MONTICELLI, BRESCIA, BR (IT)

(21) Appl. No.: 17/797,961

(22) PCT Filed: Feb. 10, 2020
(86) PCT No.: PCT/EP2020/053336

§ 371 Date: Aug. 5, 2022

(51) Int. Cl. B01D 53/04

(52) U.S. Cl. CPC B01D 53/0462; B01D 53/0446; B01D 53/0438; B01D 2257/708; B01D 2259/404

(57) ABSTRACT

Plant and method for the abatement of polluting components contained in biogas to be treated, wherein a plurality of filtering tanks suitable to be connected to a supply line of biogas to be treated contain each an adsorbing agent for the adsorption of the undesired polluting components when streams of biogas flow through each filtering tank. The plurality of filtering tanks are switched cyclically among them so that, during the operation of the plant, at least a first tank is temporarily isolated from the supply line and subjected to a regeneration phase of its adsorbing agent saturated by polluting components previously adsorbed, while one or more of the other filtering tanks remain connected with and are fed by the supply line with their respective adsorbing agent which continue adsorbing polluting components contained in the streams of biogas flowing through them.

### CROSS-REFERENCE TO RELATED APPLICATION

This application is the U.S. national phase of International Application No. PCT/EP2020/053336 filed Feb. 10, 2020, which designated the U.S. the entire contents of which are hereby incorporated by reference.

### BACKGROUND OF THE INVENTION

### Field of the Invention

The present invention concerns a plant and a method for the abatement of undesired polluting components, in particular of volatile organic compounds (“VOC”), which are contained in biogas to be treated in order to obtain purified gases, such as biomethane used for example as an energy source.

### Description of the Related Art

The use of biogas as an energy source has been widespread since long time, initially via the use of cogenerators for the production of electricity, and more recently for the production of biomethane through upgrading gas treatment plants.

The biogas can originate for example from the fermentation of animal sewage, from scraps or materials of vegetable origin, from landfills or urban waste, waste water treatment systems, et cetera, and is formed by a mixture of gases out of which for example biomethane can be extracted.

In many cases, the biogas under treatment needs to be properly purified from impurities and harmful substances contained therein, in particular volatile organic compounds, such as siloxanes.

The amount of these undesired, harmful and polluting substances may depend on the biogas production process, wherein smaller quantities can be usually found for the anaerobic digestion from agricultural sources, while substantially higher amounts are usually found in biogas produced by organic waste components.

Nowadays, the removal of VOCs is usually obtained via the use of active carbon filters which are replaced once saturated, thus forcing to temporarily stop the gas treatment process and entailing a certain cost; this is particularly disadvantageous for plants having high concentrations and capacities, i.e. a typical application of upgrading plants treating organic waste, where the cost for replacement can be rather high, and a massive production of special waste to be disposed of is generated.

Further, a high concentration of such substances can cause frequent shutdowns of various equipment used in the plant.

For example, the high concentration of siloxanes present in landfill biogas are the cause of heavy deposits in the engines present in the landfill and used for the production of electricity; these deposits cause frequent shutdowns of the engines due to preventive maintenance needed for cleaning the combustion chambers, as well as for corrective maintenance and breakage caused by the accelerated wear of components.

Clearly, any shutdown reduces the overall capacity of electricity production for each site, and also the capacity to burn the landfill biogas through the engines, which implies a use of flares greater than what would be necessary with a properly treated biogas.

### SUMMARY OF THE INVENTION

Hence, it is evident from the above that there is still room and desire for further improvements under various aspects, and it is a main aim of the present invention to at least partially mitigate at least some of the above indicated issues, and in particular to provide a solution wherein the abatement of undesired polluting components contained in biogas to be treated is executed in an improved and more efficient manner with respect to prior art solutions.

Within this aim, an object of the present invention is to provide a solution able to properly abate the amount of undesired polluting components contained in biogas to be treated while reducing, if not completely eliminating, the down times of the whole process, thus positively affecting the overall capacity of energy production.

An other object of the present invention is to provide a solution able to properly abate the amount of undesired polluting components contained in biogas to be treated while reducing at the same time the overall environmental impact.

Yet a further object of the present invention is to provide a solution able to abate the amount of undesired polluting components contained in biogas to be treated while drastically reducing the need of maintenance interventions and the replacements of components involved.

An additional object of the present invention is to provide a solution for the abatement of undesired polluting components contained in biogas to be treated which is easy to be implemented and at competitive costs.

This aim, these objects and others which will become apparent hereinafter are achieved by a plant for the abatement of polluting components contained in biogas to be treated, characterized in that it comprises at least a plurality of filtering tanks suitable to be connected to a supply line of biogas to be treated and each containing adsorbing means for the adsorption of said undesired polluting components when streams of biogas flow through each filtering tank, said plurality of filtering tanks being switched cyclically among them so that, during the operation of the plant, at least a first tank of said plurality of filtering tanks is temporarily isolated from the supply line and subjected to a regeneration phase of its adsorbing means saturated by polluting components previously adsorbed, while one or more of the remaining filtering tanks of said plurality of filtering tanks remain connected with and are fed by the supply line with their respective adsorbing means which continue adsorbing polluting components contained in the streams of biogas flowing through the one or more remaining filtering tanks.

Likewise, this aim, these objects and others which will become apparent hereinafter are also achieved by a method for the abatement of polluting components contained in biogas, characterized in that it comprises at least the following steps:

(a): providing, in a plant for the treatment of biogas, a plurality of filtering tanks suitable to be connected to a supply line of biogas to be treated and each containing adsorbing means for the adsorption of said polluting components when streams of biogas flow through each filtering tank;

(b): during the operation of the plant, switching said plurality of filtering tanks cyclically among them so that, at least a first filtering tank of said plurality of filtering tanks is temporarily isolated from the supply line of biogas;

(c): subjecting the at least a first filtering tank once isolated to a regeneration phase of the adsorbing means contained therein and saturated by polluting components previously adsorbed, while maintaining one or more of the remaining filtering tanks of said plurality of filtering tanks connected with the supply line with the respective adsorbing means which continue to adsorb the polluting components contained in the streams of biogas flowing through them.

### BRIEF DESCRIPTION OF THE DRAWINGS

Further characteristics and advantages will become apparent from the description of some preferred but not exclusive exemplary embodiments of a plant and method according to the present disclosure, illustrated only by way of non-limitative examples with the accompanying drawings, wherein:

FIG. 1 is a schematic view showing a first exemplary embodiment of a plant according to the invention;

FIG. 2 is a perspective view schematically showing a second exemplary embodiment of a plant according to the invention;

FIG. 3 is a flow chart schematically illustrating a method according to the invention, which can be carried out for example in a plant according to FIG. 1 and/or to FIG. 2.

### DESCRIPTION OF THE PREFERRED EMBODIMENTS

It should be noted that in the detailed description that follows, identical or similar components, either from a structural and/or functional point of view, have the same reference numerals, regardless of whether they are shown in different embodiments of the present disclosure; it should also be noted that in order to clearly and concisely describe the present disclosure, the drawings may not necessarily be to scale and certain features of the disclosure may be shown in somewhat schematic form.

Further, when the term “adapted” or “arranged” or “configured” or “shaped”, is used herein while referring to any component as a whole, or to any part of a component, or to a combination of components, it has to be understood that it means and encompasses correspondingly either the structure, and/or configuration and/or form and/or positioning.

In addition, when the term “substantial” or “substantially” is used herein, it has to be understood as encompassing a tolerance of plus or minus 5% with respect to an indicated or reference value or range.

Finally, in the following description and claims, the numeral cardinals first, second, third et cetera . . . , will be used only for the sake of clarity of description and in no way they should be understood as limiting for whatsoever reason; in particular, the indication of a component referred to for instance as the “fourth . . . ” does not imply necessarily the presence or strict need of the preceding “first” or “second” or “third” ones, unless such presence is clearly evident for the correct functioning of the relevant embodiment(s) described, nor that the order should be the one exactly in the numerical sequence described with reference to the illustrated exemplary embodiment(s).

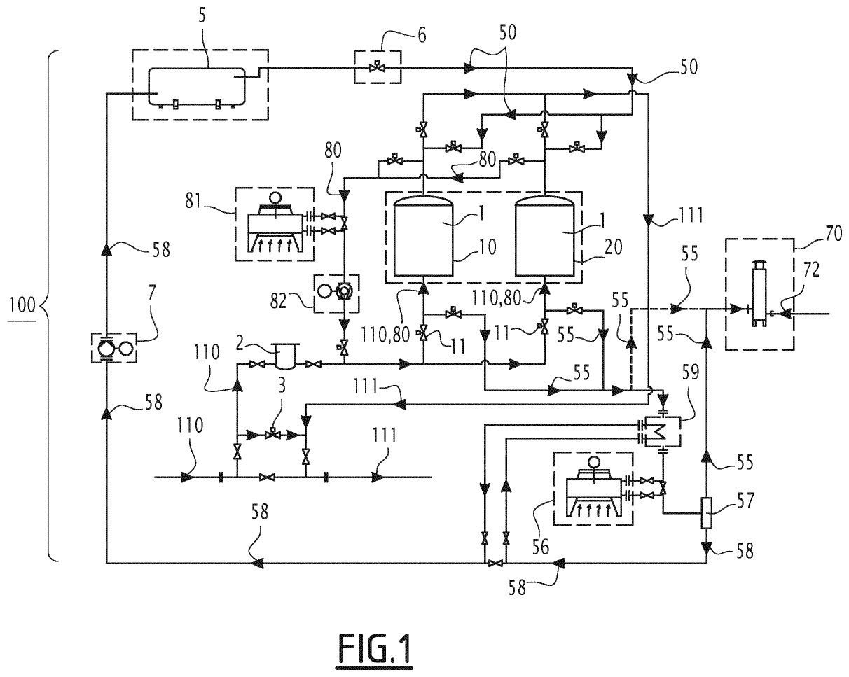

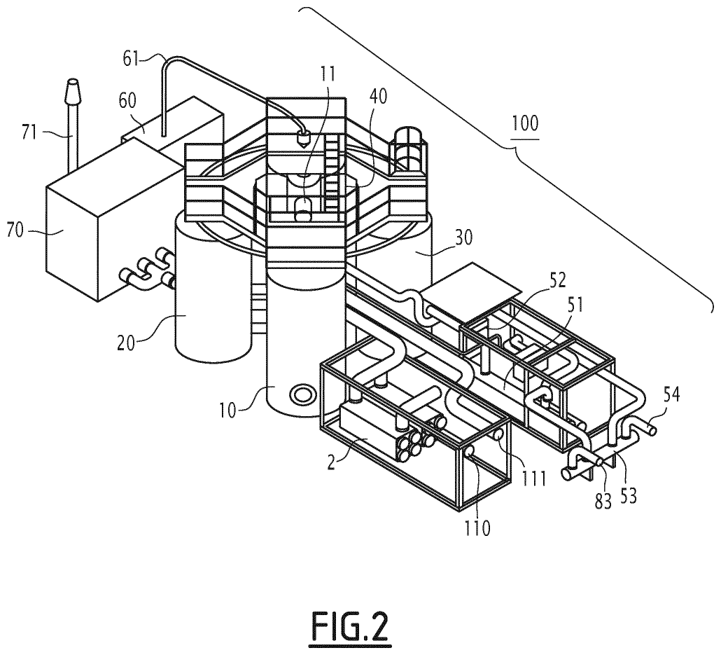

FIGS. 1 and 2 illustrate two possible embodiments of a plant according to the present invention, therein indicated by the overall reference number 100.

In particular, the plant 100 for the abatement of undesired polluting components, and especially of volatile organic compounds (‘VOCs’) contained in the biogas to be treated, comprises at least a plurality of filtering tanks, e.g. two or more suitable to be connected to a supply line 110 of biogas to be treated.

More in details, in the first embodiment illustrated in FIG. 1, there are foreseen two filtering tanks, namely a first filtering tank 10 and a second filtering tank 20, for example two identical or similar tanks arranged side by side; in the second embodiment illustrated in FIG. 2, the plant 100 comprises, in addition to the first filtering tank 10 and to the second filtering tank 20, a third filtering tank 30 and a fourth filtering tank 40.

In particular, according to the embodiment illustrated in FIG. 2, the first, second, third and fourth filtering tanks 10, 20, 30, 40 are preferably mutually arranged so as to occupy, when seen for example from a top view, each a respective quadrant of a square base.

Clearly, a different number of filtering tanks, for example three, five, six or else, can be used, as well as they can be placed in a configuration different from the ones illustrated.

Advantageously, each filtering tank 10, 20, 30, 40 contains one or more adsorbing means 1 (which can be indicated hereinafter also as filter(s) 1) for the adsorption of undesired polluting components when streams of biogas flow through each filtering tank.

According to a possible embodiment, the one or more adsorbing means 1 comprise a bed of active carbons.

Alternatively, the one or more adsorbing means 1 comprise for example silica gel. Clearly, if needed, and as those skilled in the art would readily appreciate, the filtering media used can be properly selected depending on the specific application and on the type of polluting components to be adsorbed.

Conveniently, in the plant 100 according to the present invention, the plurality of filtering tanks 10, 20, and when present 30 and 40 as well, are switched cyclically among them so that, during the operation of the plant 100, and in particular when the plant has reached its steady state of operations:
at least a first tank of the plurality of filtering tanks, for example the first filtering tank 10, is temporarily isolated or disconnected from the supply line 110, namely it is not fed with streams of biogas by the supply line 110, and is subjected to a regeneration phase of its adsorbing means 1 saturated by polluting components previously adsorbed;
while, at the same time, one or more of the remaining filtering tanks, e.g. the second filtering tank 20, and/or the third filtering tank 30 if present, and/or the fourth filtering tank 40 if present, remain connected with and are fed by the supply line 110 with the respective adsorbing means 1 which continue adsorbing polluting components contained in the streams of biogas flowing through each of them.

According to an embodiment, the plant 100 comprises, for each filtering tank, one or more valves 11, preferably a plurality of valves 11, i.e. at least two per tank. The valves 11 are adapted for switching selectively, when needed, each of the one or more filtering tanks 10, 20, 30, 40 between a connection position with the supply line 110, in which a fluid communication is established between the filtering tank(s) and the supply line itself 110 for feeding streams of biogas flowing through the connected filtering tank(s), and an isolated position in which the fluid communication between a respective filtering tank and the power supply line 110 is interrupted and therefore the flow of of biogas through the isolated tank is temporarily impeded.

In particular, according to the embodiment illustrated in FIG. 2, there is provided a unique valve structure or apparatus, for example in the form of a vertical column which is arranged centrally between the tanks and is provided with a plurality of switching valves 11, i.e. at least two per each tank. The valves 11 are connected to the various tanks 10, 20, 30, 40, and are adapted to selectively switch, each of the associated first, second, third and fourth filtering tanks 10, 20, 30, 40 between a connection position with the supply line 110 of biogas in which a filtering tank is in fluid communication with and fed by the supply line 110, and an isolated position in which the fluid communication between a filtering tank and the supply line 110 is temporarily interrupted.

Each valve 11 can be for example automatic and actuated under the control of a control system of the plant 100.

In practice, in such configuration, the assembly formed by the four tanks 10, 20, 30, 40, and the switching central column provided with valves 11, placed in between them and connected therewith, resembles a four-leaf clover, with an optimized occupation of space.

According to a possible embodiment, the plant 100 further comprises heating means for heating the adsorbing means 1 contained within each filtering tank 10, 20, 30, 40 during a regeneration phase thereof.

In particular, according to the embodiment of FIG. 1, the heating means comprise at least an injection line 50 for the injection of a heating and inerting gas inside each filtering tank under regeneration.

More in details, the heating means according to the embodiment of FIG. 1 conveniently comprise an injection line 50 connected with and adapted to inject steam inside each filtering tank when subject to the regeneration of the respective adsorbing means 1.

In particular, and according to an effective and cost efficient solution, the steam used can be part of that produced within the same plant 100, for example by a generator of steam 5.

Alternatively, as for example illustrated in the embodiment of FIG. 2, the plant 100 can further comprise means specifically provided for inerting the internal environment of each filtering tank before starting the respective regeneration phase, and in particular such means comprise for example a nitrogen source 60 and a nitrogen injection line 61 for conveying the nitrogen from the source 60 into each filtering tank; for instance, the source 60 can be a nitrogen generator for the production in situ of the nitrogen needed, or a reservoir where nitrogen can be stocked.

The generated nitrogen purifies and makes inert the internal ambient of each filtering tank going to be subjected to a regeneration phase of its filter(s) 1.

In this case, according to the embodiment of FIG. 2, the heating means comprise one or more heat exchangers or electrical heaters 51 (hereinafter heaters 51), and at least one blower 52 adapted to convey streams of ambient air towards the heat exchangers or heaters 51; accordingly, the streams of ambient air are heated up to a suitable temperature, for example up to 130° C. by the heaters 51 before being introduced in a previously inerted filtering tank under regeneration.

According to this embodiment, the heating means can further comprise an additional gas-air heat exchanger 53 for heating up streams of ambient air using heat from exhaust gases produced by one or more components or parts of the plant 100, and recirculated towards the heat exchanger 53, for example via the recirculation line 54.

In one possible embodiment, the plant 100 according to the invention comprises a disposing device 70, for example a torch or a thermoreactor, for disposing the components adsorbed by the adsorbing means 1 and transported outside each filtering tank during the respective regeneration phase, for example by means of the heating gas injected therein, e.g. the injected high pressure steam or the streams of ambient air pre-heated up, along the line 55.

To this point, according to a possible variant of the embodiment illustrated in FIG. 1, the plant 100 can comprise, positioned for example along the line 55, a condenser 56, a discharger or separator 57, a recirculation line 58 leading to the steam generator 5, and a heat exchanger 59, e.g. a regenerative heat exchanger, for the scope that will become more apparent from the following description.

According to yet a further embodiment, the plant 100 further comprises cooling means for cooling the adsorbing means 1 contained in each filtering tank after the respective phase of regeneration is completed and before reputting the regenerated filtering tank into fluid communication with the supply line 110.

In particular, as illustrated in FIG. 1, the cooling means comprise a cooling line 80 for the injection of a cooling gas through each filtering tank subjected to a regeneration phase, and a cooler 81 connected to each filtering tank and devised to cool flows of cooling gas leaving each filtering tank subjected to a regeneration phase.

In one possible embodiment, the cooling line 80 is comprised in or constituted by part of the supply line 110, and the cooling gas is preferably constituted by streams of the same biogas to be treated; in addition, the cooling means further comprises at least one blower 82 adapted to re-inject into the main supply line 110 streams of biogas, previously cooled by the cooler 81, and which are suitable to be re-introduced into one or more of the filtering tanks for the abatement of pollutants therein contained.

Clearly, if desired, a different cooling gas may be used instead of the same biogas to be treated.

Alternatively, according to the embodiment of FIG. 2, the cooling means comprises the injection line 83 for the injection of fresh ambient air through each regenerated filtering tank before connecting it with the supply line 110; the same injection line 83 is used as part of the heating means where air is injected and heated up by the one or more heater(s) 51.

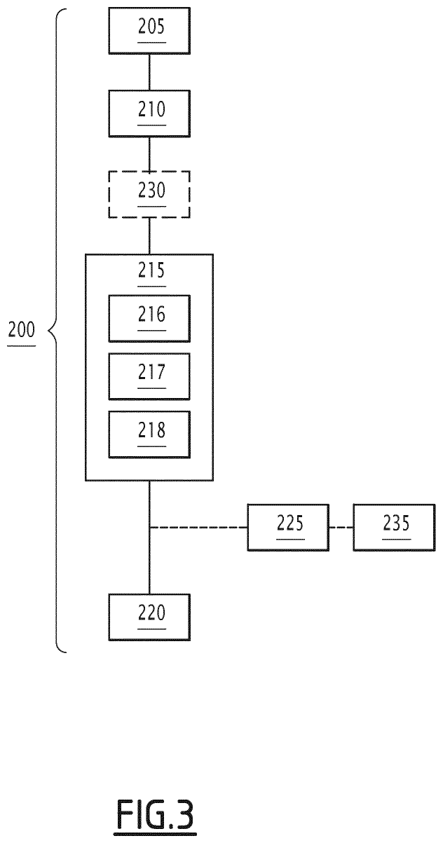

FIG. 3 illustrates schematically a method 200 for the abatement of undesired polluting components, and in particular of VOCs contained in biogas to be treated, characterized in that it comprises at least the following steps:
205: providing, in a plant 100 for the treatment of biogas, such as the one illustrated previously with respect to FIGS. 1 and 2, a plurality of filtering tanks 10, 20, 30, 40 suitable to be connected to a supply line 110 of biogas to be treated, wherein each filtering tank contains adsorbing means 1 for the adsorption of the polluting components when streams of biogas flow through each filtering tank;
210: during the operation of the plant 100, and in particular once at a steady state and/or at predetermined moments, switching the plurality of filtering tanks cyclically among them so that, at least a first filtering tank 10 of the plurality of filtering tanks is temporarily isolated from and not supplied with biogas by the supply line 110;
215: subjecting the at least a first filtering tank, once isolated from the supply line 110, to a regeneration phase of the adsorbing means 1 contained therein and saturated by polluting components previously adsorbed, while maintaining one or more of, preferably all, the remaining filtering tanks 20, 30, 40 of the plurality of filtering tanks connected with the supply line 110 with the respective adsorbing means 1 which continue to adsorb the polluting components contained in the streams of biogas flowing through the tanks connected with and fed by the supply line 110.

According to a possible embodiment of the method 200, the step 215 of subjecting the at least a first filtering tank to a regeneration step comprises the following sub-steps:
216: heating up to a suitable temperature the adsorbing means 1 contained in the first filtering tank 10 under regeneration;
217: releasing outside the first filtering tank 10 the polluting components previously adsorbed by the adsorbing means 1 contained therein, while preferably maintaining inside the first filtering tank 10 substantially the temperature previously achieved.

Further, according to one possible embodiment, the step 215 also comprises the additional sub-step 218 of dehumidifying the adsorbing means 1 contained in the first filtering tank under regeneration.

According to a possible embodiment, the sub-step 216 of heating up comprises injecting a heating, inerting gas inside the first filtering tank 10, and more in particular injecting a flow of steam inside the first filtering tank 10 under regeneration, for example at a pressure below 0,5 barg.

According to an alternative embodiment, the sub-step 216 of heating up comprises injecting streams of preheated ambient air, for example pre-heated by means of the heaters 51, at a desired suitable temperature before such air streams are introduced into the filtering tank 10 for regenerating the filter(s) 1 contained therein.

According to this alternative embodiment, the sub-step 216 of heating up further comprises recirculating, for example via the recirculation line 54, streams of exhaust gas produced by one or more components or parts of the plant 100 or by other parts not belonging to the plant 100, for example a cogenerator, and raising up the temperature of streams of ambient air, for example by means of a gas-air heat exchanger 53, using the heat of the exhaust gas recirculated.

As illustrated in FIG. 3, in one embodiment, the method 200 further comprises the step 220 of disposing of, for example by means of a torch or a thermoreactor 70, the polluting components, adsorbed by the adsorbing means 1 and transported outside each filtering tank during the respective regeneration phase, for instance by means of the hot gas injected therein.

In particular, with reference to the exemplary plant 100 of FIG. 1, when steam is injected and passes through the tank under regeneration transporting out the adsorbed components, the steam can be directly conveyed, together with the undesired components to the disposing device 70, e.g. the torch 70, directly via the line 55, following par example the dotted path in FIG. 1.

As a possible variant, the steam exiting from the tank under regeneration can pass through a condenser 56; accordingly the condenser 56 re-condenses it, and the whole stream further passes through a discharger 57 where the recondensed steam is discharged towards a recirculating line 58 which recirculates the recondensed steam to the steam generator 5; a recirculating pump 6 can be used along the line 58. The other parts, and especially the pollutants, proceed along the line 55 towards the torch 70 for being disposed of.

In this case, the pollutants contained in the steam tend to be insoluble in water and consequently remain in the gaseous phase, and this gaseous stream is easy to be disposed of due to the high concentration of pollutants and to the significantly reduced flow compared to the open cycle variant realized via the dotted path.

Accordingly, with the closed cycle thus realized, i.e. when using the condenser 56, the discharger 57, and the recirculating line 58, the amount of water consumption is reduced and makes it possible to use the plant according to the invention even in places where a continuous consumption of water is not tolerable; in addition, there is a further economic benefit since the flow to be disposed of is reduced with respect to the open cycle, and thus also the size of the disposal system and its cost can be drastically reduced.

Further, according to this embodiment, the thermal power of the steam to be condensed can be at least partially recovered, by using the thermal exchanger 59, wherein the heat recovered can be used to pre-heat the steam condensed upstream the discharger 58 and before sending it to the steam generator 5.

In a further embodiment, the method 200 further comprises the step 225 of cooling the adsorbing means 1 contained in the first filtering tank 10 once the regeneration phase of its adsorbing means 1 has been completed.

In particular, according to a possible embodiment, the step 225 of cooling comprises injecting a cooling gas into the first filtering tank 10 and cooling, for example via the cooler 81, streams of cooling gas leaving the filtering tank 10 under regeneration.

According to a possible embodiment, the cooling gas injected into the first filtering tank 10 under regeneration is constituted by streams of the same biogas to be treated and previously cooled by the cooler 81.

In a possible variant, the step 225 of cooling comprises passing streams of ambient air through the first filtering tank 10, once the regeneration step has been completed.

According to a further embodiment, the method 200 further comprises the step of inerting 230 the internal environment of the first filtering tank 10 before starting the regeneration phase of its adsorbing means 1.

In particular, the step of inerting 230 comprises using nitrogen available in the plant 100, for example produced in situ, and injecting the nitrogen available inside the first filtering tank 10 to be regenerated, to purify it from the presence of biogas and to make its internal ambient inert, before subjecting the first filtering tank to the regeneration phase.

Likewise, according to a further embodiment, the method 200 further comprises the step of re-inerting 235 the internal environment of the first filtering tank 10 after the regeneration phase has been completed and before reconnecting the regenerated thank to the supply line 110 in order to restart filtering.

For example, also the re-inerting phase 235 can be executed via using nitrogen available in the plant 100, for example produced in situ, and injecting the nitrogen available inside the first filtering tank 10 to be regenerated, to purify it from the presence of air and related oxygen, before reconnecting the regenerated thank to the supply line 110.

In practice, in the plant 100 and method 200 according to the present invention, during the filtration phase the tanks connected with the main supply line 110 line adsorb the undesired polluting components contained in the flows of biogas passing through the tanks. The purified gas is returned to the main line 110 for further treatment or directly to users as required and/or depending on the applications, for example via the outlet line 111.

A bypass 3 can be provided between the incoming supply line 110 and the outlet line 111; such by pass can be used for instance to divert the biogas directly to the outlet line 111 without entering the tanks, in case for example of alarms or maintenance intervention that force anyhow to put the treatment system out of operations.

As illustrated for example in FIG. 1, optionally the biogas to be treated can be passed through a prefilter 2, before entering the various filtering tanks.

Once the adsorbing means 1 contained in a filtering tank reach the saturation level, the relevant tank is isolated, for instance by means of the valve(s) 11, from the supply line 110 in order to interrupt temporarily the supply of biogas and carry out the regeneration phase of the adsorbing means 1 contained therein.

At the same time, the operations of the plant are not interrupted since the other tank(s) remain connected with and fed by the supply line 110, thus continuing to adsorb the undesired contaminants.

Depending on the specific applications and related relevant operational parameters, such as for example sizing of the whole system and parts thereof, for instance of the adsorbing means, the flow rate of biogas, the concentrations of pollutants to be filtered, experimental tests, et cetera, the duration of the filtration phase up to reaching saturation, can be properly calculated for each tank and predefined in the control system of the plant, or it can be defined/refined in real time via data provided by suitable sensors associated to the adsorbing means 1 and/or the tanks.

Conveniently, and as previously described, when using as adsorbing means active carbons or any equivalent type of media, the regeneration phase exploits the ability of the active carbons to release the adsorbed substances by means of a temperature increase, namely the so called “Temperature Swing Adsorption” or “TSA” technique.

More in details, according to the embodiment of FIG. 1, the thermal power required to properly increase the temperature of the adsorbing means 1 is given by the use of steam which guarantees an excellent heat exchange and directly the maintenance of an inert atmosphere inside the tank.

Hence, the regeneration step of the adsorbing means 1 comprises a first part (sub step 216 previously described) of heating up, wherein steam is injected into the tank, it condenses once in contact with the adsorbing means 1, and thus it transfers its latent heat to the adsorbing means themselves. In particular, the streams of steam are injected, inside the tank under regeneration, via the heating line 50 and in a direction opposite (counter-stream) with respect to that of the streams of biogas to be treated and supplied by supply line 110.

By using the steam, preferably produced within the same plant for example by the steam generator 5, the thermal exchange in transition phase is optimal and the heating process is faster if compared for example with the use of another hot gas.

Thus, the bed of active carbons is brought to a proper temperature, for example above 100° C.; this temperature can be properly predefined, in particular within a predefined and desired range, e.g. up to 150° C., and can be controlled for example via suitable sensors.

Already during this phase, a minor part of the contaminants, typically, VOCs, previously adsorbed, may be released outside the tank under regeneration.

Then (sub-step 217 previously described), the desired temperature achieved is substantially maintained inside the tank by continuing the injection of steam, and in this sub-step the remaining and majority part of the substances previously adsorbed by and contained in the active carbons is transported outside the tank by the flows of steam passing through the tank itself.

Also the duration of this part can be properly predefined and/or properly controlled in real time via data provided by suitable sensors.

After the releasing sub-step is completed, the injection of steam inside the tank is continued; in this phase (sub-step 218 previously described), and unlike the heating up sub-step, the injected steam does not condense but it provides the thermal power necessary to re-evaporate the part of condensates which may be contained in the active carbons and that would limit the future adsorption of VOCs when the regenerated adsorbing means would be put back in line.

For the entire duration of the previous phases, the disposal device or means 70 of the plant are active. As previously mentioned, according to a first variant, the flows of steams exiting the tank under regeneration and transporting the undesired components are directly conveyed, via the line 55 to the disposal means, for example to a torch 70 supplied by a line of methane 72, which guarantees the correct combustion of the undesired components, especially the VOCs, via oxidation.

According to a second possible variant, the steam exiting from the tank under regeneration can be re-condensed by passing through the condenser 56; then, the whole stream passes through the discharger 57 where the recondensed steam is discharged into the recirculating line 58 and conveyed to the steam generator 5 while the remaining parts, and especially the pollutants, proceed towards the torch 70 via the line 55 for being disposed of.

In the meanwhile, once the regeneration is completed, the adsorbing means 1 are cooled before the tank is reconnected with the supply line 100 for restarting filtering, in particular to properly re-establish their capabilities of adsorbing the undesired pollutants, and especially the VOCs, and also to prevent an excessive increase of the temperature of the biogas to be filtered and afterwards to be sent to subsequent components of the plant 100.

To this end, and in order to ensure an inert atmosphere inside the regenerated tank even at this stage, thus further improving the overall safety of the plant, preferably the same biogas to be treated is used as cooling gas.

In particular, streams of biogas are injected inside the regenerated tank, for example via the cooling line 80, which can be part for example of the supply line 110; such streams, by passing through the adsorbing means 1, remove thermal power from the previously heated-up active carbons.

Then, the streams of biogas exiting the tank, can be conveyed, via the line 80, for example towards the cooler 81 where, by cooling, they transfer the thermal power to the external environment; once cold, the biogas is re-injected by means of the blower 82 in the main line 110 where it is mixed with newly coming streams of biogas for the proper treatment thereof via the connected filtering tanks.

Once the temperature of the regenerated adsorbing means 1 reaches substantially the value suitable for adsorption, for example 50° C., it is possible to put the tank back on line, and to start the regeneration of the adsorbing means contained in another tank which has reached the saturation level, exactly as previously described for the first tank 10.

Likewise, according to the embodiment of FIG. 2, while a tank, e.g., the first tank 10 has to be regenerated, the biogas, after optionally flowing for example through the prefiltering cartridge 2, passes through one or more, preferably all, the remaining tanks 20, 30, 40 and is purified by the adsorbing means 1 contained therein.

Since the tank 10 that needs to be regenerated is still full of biogas, in order to avoid the creation of a potentially explosive mixture of gas and air, an inertization procedure is carried out; hence, as previously described, the nitrogen available from the source 60 is injected into the tank 10 to purge it from biogas. When the tank is purged, it is possible to proceed further with the regeneration phase. In particular (at sub-step 216 previously described) ambient air is directed by means of the blower 52 and conveyed to the electrical heater(s) 51, which heat(s) up the air at a certain desired temperature, for instance 130° C.

As indicated, in a possible embodiment, an additional exhausted gas—air heat exchanger 53 can be used for increasing the temperature of the ambient air using the heat of exhausted gas recirculated via the recirculation line 54. This would reduce the electrical consumption of the heaters 51. The recirculated gas can originate for example from engines not illustrated in the figures.

The heated-up ambient air passes through the tank 10 to raise the temperature of the adsorbing means 1 up to a suitable temperature at which the accumulated adsorbed pollutants are detached from the adsorbing means 1 and transported outside the tank 10 by the same flow of preheated ambient air.

This air flow is then directed to the disposing means 70, e.g. an existing flare or, as for example illustrated in FIG. 2, a regenerative thermoreactor 70 which is devised to operate the combustion of pollutants collected from the air stream before sending them to an exhausting chimney 71.

Once the regeneration phase is completed, the heater(s) 51 is(are) shut off and the system continues to flow fresh air through the newly regenerated tank 10 in order to cool the adsorbing means 1 contained therein.

Also in this embodiment, in order to avoid the creation of a potentially explosive mixture of gas and air, an inertization procedure is again executed before putting the regenerated tank 10 back in line for new filtering cycles.

Accordingly, the nitrogen available from the source 60 is newly injected into the tank 10 to purge it from air and related oxygen.

The newly regenerated tank 10, once cooled and inerted, is again ready to be placed in line with the other non-saturated tanks, while a saturated tank, e.g. the second tank 20 is then isolated and put into the regeneration process exactly as previously described for the first tank 10.

Hence, it is evident from the foregoing description and appended claims that the plant 100 and method 200 according to the present invention allow achieving the intended aim and objects since they allow a strong abatement of undesired contaminants present in the biogas, without interrupting completely the process of treating the biogas, and thus increasing the production of electricity due to the reduced time of machines and equipment put out of orders.

From an environmental point of view, the amount of special waste to be disposed of is drastically reduced, and the pollutants extracted from the biogas and captured by the adsorbing means are released during the regeneration process and properly and more efficiently disposed of.

These results are achieved according to solutions which allow also a strong reduction of operational costs since, for example, the adsorbing means can be replaced less frequently, there is achieved a reduced wear of various components, and therefore the maintenance intervals can be extended. Also safety is improved, since the tanks always operate in conditions of inert atmosphere, avoiding the need for complicated inerting systems and more onerous safety procedures.

The plant 100 and method 200 thus conceived are susceptible of modifications and variations, all of which are within the scope of the inventive concept as defined in particular by the appended claims, including any combination of the individual embodiments or parts/features thereof which can be envisaged within the frame and scope of the present invention.

For example, in relation to a specific application, some of the components, e.g. the tanks can be positioned differently; the filtering media used in the tanks can be of different type; the regeneration of the adsorbing means can be executed using other techniques with respect to what described; the various lines described can be formed by separated and distinct conduits, or where possible, at least some of them can be formed at least in parts by commonly shared pipes; as those skilled in the art can easily appreciate, some steps or substeps of the method 200 are not strictly needed in each of the embodiments or variants described, and/or they can be executed in parallel or in a sequence different from the one exemplary illustrated.

All the details may furthermore be replaced with technically equivalent elements.

1. Plant for the abatement of polluting components contained in biogas to be treated, comprising at least:
a plurality of filtering tanks suitable to be connected to a supply line of biogas to be treated and each containing adsorbing means for the adsorption of said undesired polluting components when streams of biogas flow through each filtering tank, said plurality of filtering tanks being switched cyclically among them so that, during the operation of the plant, at least a first tank of said plurality of filtering tanks is temporarily isolated from the supply line and subjected to a regeneration phase of its adsorbing means saturated by polluting components previously adsorbed, while one or more of the remaining filtering tanks of said plurality of filtering tanks remain connected with and are fed by the supply line with their respective adsorbing means which continue adsorbing polluting components contained in the streams of biogas flowing through the one or more remaining filtering tanks.

2. The plant according to claim 1, further comprising, for each filtering tank, one or more valves for switching selectively each of said one or more filtering tanks between a connection position with the supply line in which a fluid communication is established between a respective filtering tank and the supply line itself, and an isolated position in which the fluid communication between a respective filtering tank and the power supply line is interrupted.

3. The plant according to claim 1, wherein said plurality of filtering tanks comprises at least a first filtering tank and a second filtering tank.

4. The plant according to claim 3, wherein said plurality of filtering tanks further comprises a third filtering tank and a fourth filtering tank, said first, second, third and fourth filtering tanks being mutually arranged so as to occupy each a respective quadrant of a square base with a valve apparatus arranged centrally between them and comprising for each tank, one ore more valves adapted to switch each of said first, second, third and fourth filtering tanks between a connection position with the supply line of biogas in which a filtering tank is in fluid communication with the supply line, and an isolated position in which the fluid communication between a filtering tank and the supply line is temporarily interrupted.

5. The plant according to claim 1, further comprising heating means for heating said adsorbing means contained within each filtering tank during a regeneration phase thereof.

6. The plant according to claim 5, wherein said heating means comprise an injection line for the injection of a heating, inerting gas into each filtering tank.

7. The plant according to claim 6, wherein said heating means comprise a steam generator and an injection line for the injection of steam inside each filtering tank.

8. The plant according to claim 7, further comprising a condenser for recondensing the steam exiting out from the tank under regeneration, a discharger for discharging the recondensed steam into a recirculation line adapted to convey the recondensed steam towards the steam generator.

9. The plant according to claim 8, wherein it further comprises a heat exchanger adapted to at least partially recover heat from the steam exiting the tank under regeneration and to pre-heat the steam condensed using the heat recovered.

10. The plant according to claim 5, wherein said heating means comprise one or more heaters and at least one blower adapted to convey ambient air towards said one or more heaters to heat it up before being introduced in a filtering tank for the regeneration of the adsorbing means contained therein.

11. The plant according to claim 10, wherein said heating means further comprise an additional gas-air heat exchanger for heating up streams of ambient air using heat from exhaust gases produced by one or more components belonging or external to the plant and recirculated towards the gas-air heat exchanger via a recirculation line.

12. The plant according to claim 1, further comprising cooling means for cooling the adsorbing means contained in each filtering tank after the respective phase of regeneration is completed.

13. The plant according to claim 12, wherein said cooling means comprise a cooling line for the injection of a cooling gas inside each filtering tank subjected to a regeneration phase, and a cooler connected to each filtering tank and devised to cool streams of cooling gas leaving each filtering tank subjected to a regeneration phase.

14. The plant according to claim 13, wherein said cooling line is comprised or constituted by part of said supply line, and said cooling gas is constituted by streams of said biogas to be treated, and wherein the cooling means further comprise at least one blower adapted to re-inject into said supply line streams of said biogas previously cooled by said cooler and suitable to be re-introduced into one or more of said filtering tanks.

15. The plant according to claim 12, wherein said cooling means comprises an injection line for injecting fresh ambient air inside each filtering tank.

16. The plant according to claim 1, further comprising means for inerting the internal environment of each filtering tank.

17. The plant according to claim 16, wherein said means for inerting the internal environment of each filtering tank comprises a nitrogen generator and a nitrogen injection line for introducing the nitrogen produced inside each filtering tank.

18.-19. (canceled)

20. Method for the abatement of polluting components contained in biogas, comprising: providing, in a plant for the treatment of biogas, a plurality of filtering tanks suitable to be connected to a supply line of biogas to be treated and each containing adsorbing means for the adsorption of said polluting components when streams of biogas flow through each filtering tank; during the operation of the plant, switching said plurality of filtering tanks cyclically among them so that, at least a first filtering tank of said plurality of filtering tanks is temporarily isolated from the supply line of biogas; subjecting the at least a first filtering tank once isolated to a regeneration phase of the adsorbing means contained therein and saturated by polluting components previously adsorbed, while maintaining one or more of the remaining filtering tanks of said plurality of filtering tanks connected with the supply line with the respective adsorbing means which continue to adsorb the polluting components contained in the streams of biogas flowing through them.

21. The method according to claim 20, wherein said subjecting the at least a first filtering tank to a regeneration step comprises at least the following: heating up to a desired temperature the adsorbing means contained in the first filtering tank under regeneration; releasing outside the first filtering tank the polluting components previously adsorbed by the adsorbing means contained therein.

22. The method according to claim 21, wherein said subjecting the at least a first filtering tank to a regeneration step comprises dehumidifying the adsorbing means contained in the first filtering tank under regeneration.

23.-35. (canceled)
